(19) United States
(12) Patent Application Publication
(10) Pub. No.: US 2014/0222595 A1
(43) Pub. Date: Aug. 7, 2014

(54) Payment Systems and Methods

(71) Applicant: Quisk, Inc., Sunnyvale, CA (US)

(72) Inventor: Jorge M. Fernandes, Danville, CA (US)

(73) Assignee: Quisk, Inc., Sunnyvale, CA (US)

(21) Appl. No.: 14/248,318

(22) Filed: Apr. 8, 2014

Related U.S. Application Data
(63) Continuation-in-part of application No. 11/897,413, filed on Aug. 29, 2007.
(60) Provisional application No. 60/842,102, filed on Sep. 5, 2006.
(60) Provisional application No. 60/925,054, filed on Apr. 17, 2007.
(60) Provisional application No. 60/926,893, filed on Apr. 30, 2007.

(51) Int. Cl. G06Q 20/32; G06Q 20/36

(52) U.S. Cl. CPC G06Q 20/3223; G06Q 20/3676
USPC 705/16

(57) ABSTRACT

Disclosed herein is a method, in which each step is computer-implemented, including receiving, via a point of sale terminal, a mobile device telephone number of a mobile device associated with a user, and a personal identification number selected by the user. The mobile device telephone number is checked against a database to determine if the mobile device telephone number is already present. A payment account is created if the mobile device telephone number is not already associated with a payment account. The mobile device telephone number serves as an account number. An account confirmation message is transmitted to the mobile device via direct use of the account number. A transfer of funds to affect payment is administered via a stored fund account. The stored fund account is associated with the account number, and is a ledger of actual funds where the actual funds are located in a second account.

### CROSS REFERENCE TO RELATED APPLICATIONS

This patent application is a continuation-in-part of U.S. patent application Ser. No. 11/897,413 filed Aug. 29, 2007 which claims priority to U.S. Provisional Application No. 60/842,102 filed Sep. 5, 2006 titled “Cardless, Cashless, Wireless Electronic Payment System,” U.S. Provisional Application No. 60/925,054 filed Apr. 17, 2007 titled “Payment Systems and Methods,” and U.S. Provisional Application No. 60/926,893 filed Apr. 30, 2007 titled “Payment Systems and Methods,” all of which are incorporated by references herein.

### BACKGROUND

The present invention relates to payment systems, and in particular, to payment systems that interact with mobile telephones.

Unless otherwise indicated herein, the approaches described in this section are not prior art to the claims in this application and are not admitted to be prior art by inclusion in this section.

A wide variety of payment methods exist for the casual purchase of goods and services by consumers. Four important methods are checks, cash, credit cards and debit cards. However, each of these three methods has drawbacks that make them undesirable in certain circumstances, from both a consumer perspective and a merchant perspective.

Regarding the disadvantages of checks, from a consumer perspective, the consumer must possess the checkbook at the time of purchase, and may have to manually track the account balance. From a merchant perspective, checks are susceptible to fraud.

Regarding the disadvantages of cash, from a consumer perspective, often the consumer does not possess the requisite amount of cash at the time the consumer would like to make a purchase. From a merchant perspective, cash is a temptation for theft. In addition, some merchants believe that consumers spend more when not using cash.

Regarding the disadvantages of credit cards, often there are charges associated with a credit card. The consumer may see these charges as interest on outstanding balances, yearly fees, etc. The merchant may see these charges as an amount or percentage paid to the credit card service company for transactions. Many credit cards require the consumer to present the card when used, so the consumer must carry the card. The consumer may lose the credit card, and the lost card may be found and used by others until the credit account is canceled. Many credit cards have magnetic strips that can become de-magnetized, or the card may be otherwise damaged, rendering the card non-operational even when in the consumer's possession.

Regarding the disadvantages of debit cards, from a consumer perspective, some debit cards are applicable only to a particular merchant, and the consumer must remember to possess and to use the appropriate card at the appropriate time. From a merchant perspective, debit cards have associated charges similar to those of credit cards. Many debit cards require the consumer to present the card when used, so the consumer must carry the card. Many debit cards have magnetic strips that can become de-magnetized, or the card may be otherwise damaged, rendering the card non-operational even when in the consumer's possession. Finally, many consumers are reluctant to give direct access to their bank accounts by using a debit card.

There is a need for a payment system as easy to use as cash but more secure, and with lower transaction costs than credit cards and debit cards. In addition, there is a need to transfer money between individuals without the proximity requirement of cash, without the transaction costs of credit or debit cards, and without the delay of sending a check.

Thus, there is a need for improved payment systems and methods. The present invention solves these and other problems by providing a payment system that uses a well-known number and a verification code to access a consumer's account.

### SUMMARY

Disclosed herein is a method, in which each step is computer-implemented, includes the steps of receiving, via a point of sale terminal operated by a merchant, a mobile phone telephone number of a mobile phone associated with a user, and a personal identification number selected by the user. The mobile phone telephone number is checked against a database of account numbers administrated by a payment service to determine if the mobile phone telephone number is already present in the first database. A payment account for the user is created using an account server if the mobile phone telephone number is not already associated with a payment account in the database. The mobile phone telephone number serves as an account number for the payment account. An account confirmation message is transmitted to the mobile phone associated with the user via direct use of the account number for the payment account. A transfer of funds to affect payment for a payment transaction is administered via a stored fund account. The stored fund account is associated with the account number, and is a ledger of actual funds where the actual funds are located in a second account.

In another embodiment, a method, in which each step is computer-implemented, includes the steps of receiving, via a point of sale terminal operated by a merchant, a mobile phone telephone number of a mobile phone associated with a user, and a personal identification number selected by the user. The mobile phone telephone number is checked against a database of account numbers administrated by a payment service to determine if the mobile phone telephone number is already present in the first database. A payment account for the user is created using an account server if the mobile phone telephone number is not already associated with a payment account in the database. The mobile phone telephone number serves as an account number for the payment account. An account confirmation message is transmitted to the mobile phone associated with the user via direct use of the account number for the payment account. A transfer of funds to affect payment for a payment transaction is administered via an electronic wallet. The electronic wallet is associated with the account number, stores funding source information, and is stored in an electronic memory that is administrated by the account server. The funding source information is one of a credit card number, a debit card number, a gift card number or a bank account number.

In another embodiment, a method, in which each step is computer-implemented, includes the steps of receiving, via a point of sale terminal operated by a merchant, a mobile phone telephone number of a mobile phone associated with a user, and a personal identification number selected by the user. The mobile phone telephone number is checked against a database of account numbers administrated by a payment service to determine if the mobile phone telephone number is already present in the first database, or if the mobile phone telephone number is already associated with a payment account in the first database. A payment account for the user is created using an account server if the mobile phone telephone number is not already associated with an existing payment account in the database. The mobile phone telephone number serves as an account number for the payment account. The payment account is associated with a prepaid account. The prepaid account may be used to pay for usage of the mobile phone associated with the user. An account confirmation message may be transmitted, via direct use of the account number for the payment account, to the mobile phone associated with the user. A transfer of funds to affect payment for a payment transaction is administered via the prepaid account. The prepaid account stores funds that are administrated by the mobile phone provider for the benefit of the user.

The following detailed description and accompanying drawings provide a better understanding of the nature and advantages of the present invention.

### BRIEF DESCRIPTION OF THE DRAWINGS

FIG. 1 is a block diagram of a payment system 100 according to an embodiment of the present invention;

FIG. 2 is a block diagram of a basic payment system 200 according to an embodiment of the present invention;

FIG. 3 is a flowchart of a transaction process 300 according to an embodiment of the present invention;

FIG. 4 is a block diagram of a standalone point of sale (POS) system 400 according to an embodiment of the present invention;

FIG. 5 is a block diagram of an integrated point of sale (POS) system 500 according to an embodiment of the present invention;

FIG. 6 is a flowchart of an account creation method 600 according to an embodiment of the present invention;

FIG. 7 is a flowchart of a data formatting process according to an embodiment of the present invention;

FIG. 8 is a block diagram of a web merchant interface system according to an embodiment of the present invention;

FIG. 9 is a flowchart of a gift certificate purchase process 900 according to an embodiment of the present invention;

FIG. 10 is an example flowchart for methods for enabling a payment service to process a payment transaction;

FIG. 11 illustrates an example system to affect payment for a payment transaction via a stored fund account;

FIG. 12 illustrates an example system to affect payment for a payment transaction via an electronic wallet; and

FIG. 13 illustrates an example system to affect payment for a payment transaction via a prepaid mobile phone account.

### DETAILED DESCRIPTION

Described herein are techniques for performing payment transactions. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Various methods and procedures are described below. The method steps are shown in a specific order for ease of description. Note that not all steps are required in every embodiment, that the order of the method steps may be varied, and that many method steps may be performed in parallel, as desired in various implementations. A method step is not required to follow another step except when completion of the first step is absolutely required to perform the second step. Such cases will be evident from the context of the description or will be pointed out explicitly.

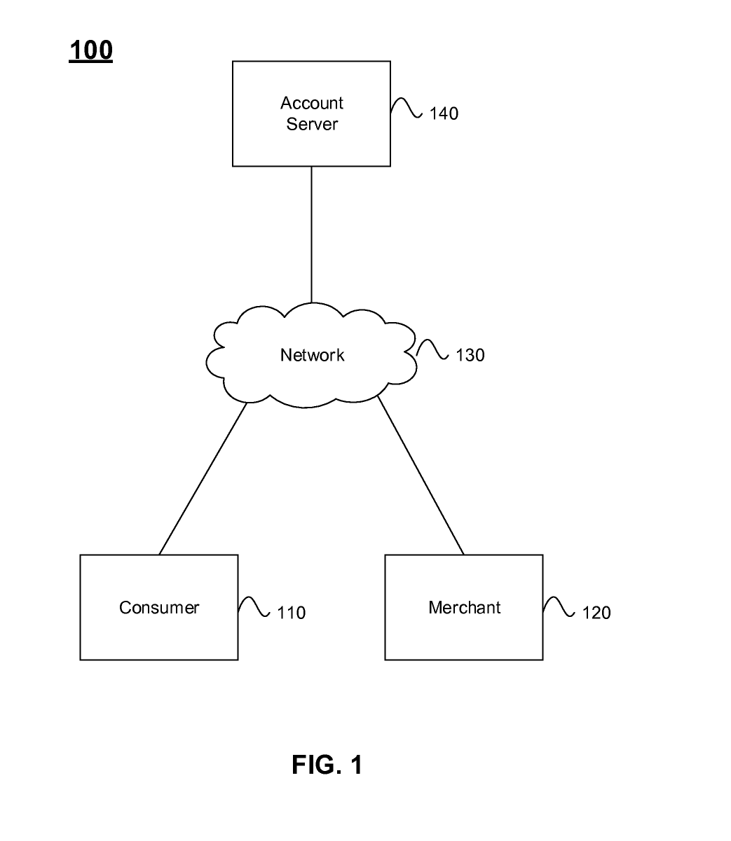

FIG. 1 is a block diagram of a payment system 100 according to an embodiment of the present invention. The payment system 100 includes a consumer interface 110, a merchant interface 120, and an account server 140. A network 130 connects the consumer interface 110 and the merchant interface 120 with the account server 140. A consumer accesses the payment system 100 via the consumer interface 110. A merchant accesses the payment system 100 via the merchant interface 110.

The consumer may generally be a person or other entity that desires to enter into a commercial transaction with the merchant. The merchant may be an individual, a business or other entity that desires to enter into a commercial transaction with the consumer. Often the consumer and the merchant will be in close proximity at the time of the commercial transaction, for example, when the consumer is purchasing an item sold (or service performed) by the merchant at a store location that hosts the consumer interface 110 and the merchant interface 120.

The network 130 may be an internet protocol (IP) network, a dedicated network, a dialup connection, etc. depending upon the specific implementation desired for the payment system 100. The consumer may interact with the account server 140 at the location of the merchant (for example, at a store), in which case the consumer interface 110 and the merchant interface 120 may access the network 130 using the same physical connection.

The account server 140 stores account data related to the consumer and the merchant. In brief, the account data indicates whether a particular transaction is authorized from the consumer to the merchant. The account server 140 then communicates the authorization to the merchant interface 120, communicates a confirmation to the consumer, and updates the account data of the consumer and of the merchant to reflect the transaction. This process is more fully described in subsequent sections.

One feature of the payment system 100, according to one embodiment, is that the consumer uses the consumer's mobile telephone number as an account number to access the payment system 100. Such access may be additionally secured with a verification code or personal identification number (PIN) code.

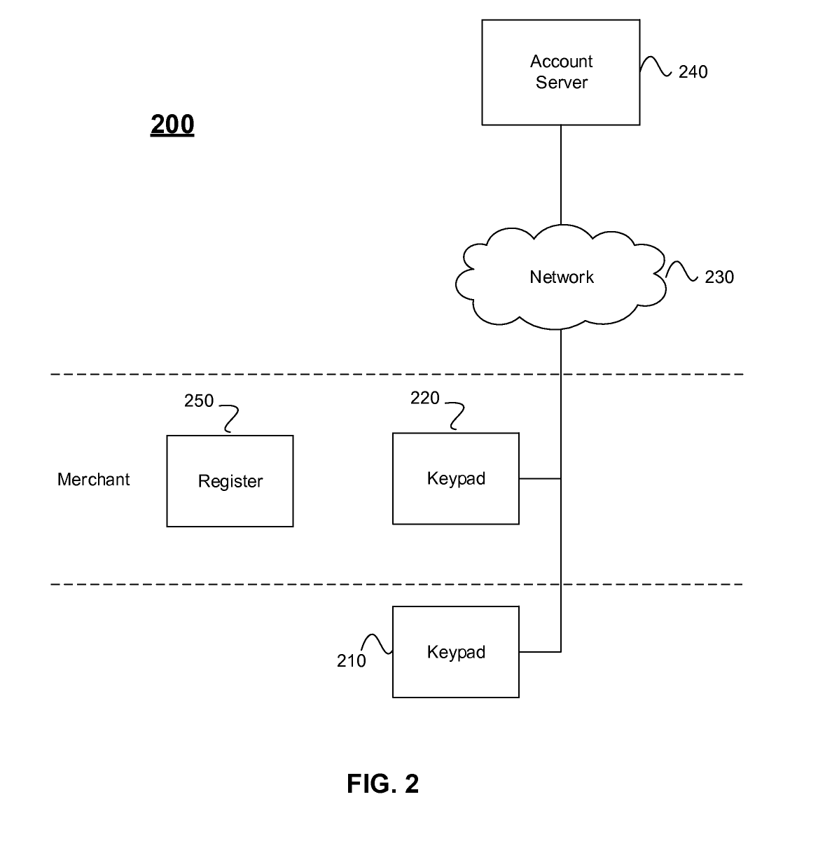

FIG. 2 is a block diagram of a basic system 200 according to an embodiment of the present invention. The basic system 200 includes a consumer keypad 210, a merchant keypad 220, and an account server 240. A network 230 connects the consumer keypad 210 and the merchant keypad 220 with the account server 240. The merchant may use a register 250 to perform the traditional functions of a cash register. Additional devices may be present, either separate or integrated with the register 250, such as credit and debit card processing devices, etc.

The consumer keypad 210 may include keys and a display. The merchant keypad 220 may include keys, a display, and a printer. Further options regarding the consumer keypad 210 and the merchant keypad 220 are discussed below.

The network 230 may be an internet protocol (IP) network, a dedicated network, a dialup connection, etc. depending upon the specific implementation desired for the payment system 200. The consumer may interact with the account server 240 at the location of the merchant (for example, at a store), in which case the consumer keypad 210 and the merchant keypad 220 may access the network 230 using the same physical connection.

According to one embodiment, the network 230 may be an existing network for transmitting commercial transaction information, for example, credit and debit card transaction information. In such embodiment, the consumer keypad 210 and the merchant keypad 220 may communicate with the account server 240 with information formatted in ISO 8583 format.

The account server 240 may be implemented on a computer system. The computer system includes hardware and software for storing the account data and updating the account data in accordance with authorized transactions.

The consumer uses the consumer keypad 210 to enter and confirm the consumer's account number and verification code. The merchant uses the merchant keypad 220 to enter and confirm the transaction amount. The account server 240 authorizes the transaction and manages account balances of the consumer and the merchant.

For simplicity, only one set of keypads are shown in FIG. 2. Additional sets of keypads may be implemented in the basic system 200, each having similar functionality. For example, an additional set of keypads may exist at a second merchant location. As another example, an additional set of keypads may exist at a single merchant location, each set being associated with its own cashier station or register.

The physical connection between the consumer keypad 210, the merchant keypad 220 and the network 230 may be modified as desired. According to one embodiment, the consumer keypad 210 and the merchant keypad 220 each connect to the network 230 independently. According to another embodiment, the consumer keypad 210 is connected to the merchant keypad 220, and the merchant keypad 220 connects to the network 230. According to still another embodiment, the merchant keypad 220 is connected to the consumer keypad 210, and the consumer keypad 210 connects to the network 230.

The basic system 200 is so named because it may be easily deployed alongside existing transaction systems, such as a traditional cash register.

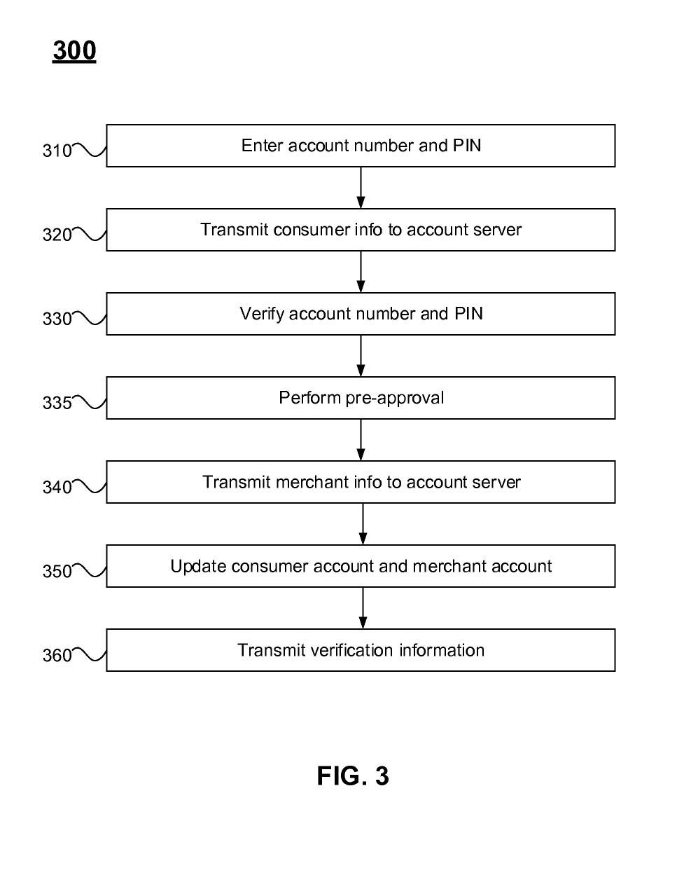

FIG. 3 is a flowchart of a transaction process 300 according to an embodiment of the present invention. The transaction process 300 will be described with reference to the basic system 200 (see FIG. 2). However, many of the steps in the transaction process 300 are also applicable to other embodiments of the present invention.

In step 310, the consumer interacts with the consumer keypad 210 to perform the consumer's part of the transaction. Generally, this involves the consumer entering the consumer's information into the consumer keypad 210. The consumer's information includes the consumer's account number and the consumer's verification code. The consumer's account number may be the telephone number of the consumer's mobile telephone. The verification code may be a personal identification number (PIN).

In step 320, the consumer keypad 210 transmits the account number and the verification code to the account server 240 via the network 230. According to one embodiment, the account number and the verification code may be encapsulated in an ISO 8583 message format for transmission over existing transaction networks. The consumer keypad 210 may also transmit additional information to the account server 240. Such additional information may include source identification information that identifies the consumer keypad 210 among the various consumer keypads (not shown in FIG. 2) that may also access the account server 240. The account server 240 may also use the source identification information to access other information the account server 240 may have regarding the consumer keypad 210, for example, that the consumer keypad 210 is associated with a type of merchant (e.g., a McDonald's restaurant), with a specific merchant (e.g., the McDonald's restaurant at a specific location), or with a specific merchant keypad (e.g., register #1 at the McDonald's restaurant a specific location), etc.

In step 330, the account server 240 receives the account number and the verification code (and any additional information). The account server 240 accesses the consumer's account and verifies that the verification code is correct.

In step 335, as an optional step, the account server 240 performs pre-approval of the transaction. After the account server has performed step 330, the account server 240 sends pre-approval information to the merchant keypad 220. The pre-approval information may include a verification that the account exists, the account balance, etc.

In step 340, the merchant interacts with the merchant keypad 220 to perform the merchant's part of the transaction. Generally, the merchant enters the purchase price of the transaction into the merchant keypad 220. The merchant keypad 220 transmits the purchase price to the account server 240.

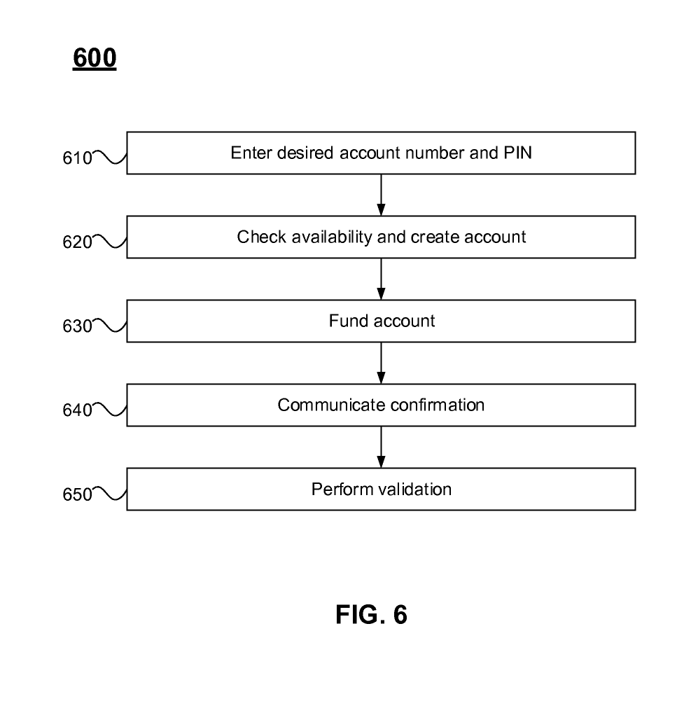

If the optional pre-approval step 335 is performed, then the merchant keypad 220 may perform additional functions in step 340. If the pre-approval information indicates that the account does not exist, the merchant may prompt the consumer to create an account (further described below with reference to FIG. 6). If the pre-approval information indicates that the consumer's balance is more than the purchase price, the merchant may indicate to the consumer that the transaction has been approved immediately upon entry of the purchase price. The consumer may then proceed without having to wait for the merchant keypad 220 to transmit the purchase price to the account server 240 (part of step 340), for the account server 240 to update the accounts (step 350), or for the account server to communicate the verification information (step 360). This pre-approval step may be contrasted with many existing payment systems, which only indicate approval after the merchant has transmitted the merchant's information. In such existing systems, the consumer must often wait in the vicinity of the merchant until the merchant has received confirmation that the transaction has been approved.

In step 350, the account server 240 updates the accounts of the merchant and the consumer. The account server 240 indicates in the consumer's account a debit (to the merchant), and in the merchant's account a credit (from the consumer).

In step 360, the account server 240 communicates verification information indicating completion of the transaction. The verification information may include the details of the transaction, such as the date, time, amount, location, etc. The verification information may be transmitted to the merchant keypad 220, to the consumer keypad 210, or to other devices. The merchant keypad 220 may use the verification information to display a message that the transaction has been completed, to print a receipt, etc. The consumer keypad 210 may use the verification information to display a message that the transaction has been completed, to print a receipt, etc.

The verification information may also be transmitted to a mobile telephone. According to one embodiment, the consumer's account number is the consumer's mobile telephone number. In such a case, the account server 240 directly uses the consumer's account number to send the verification information to the consumer's mobile telephone. Such direct access may be contrasted with a system in which the account number differs from the telephone number, which may involve an intermediate database lookup step to get the telephone number for a given account number.

Because the consumer's mobile telephone will often be in close proximity to the consumer, sending the verification information to the mobile telephone helps to reduce fraud.

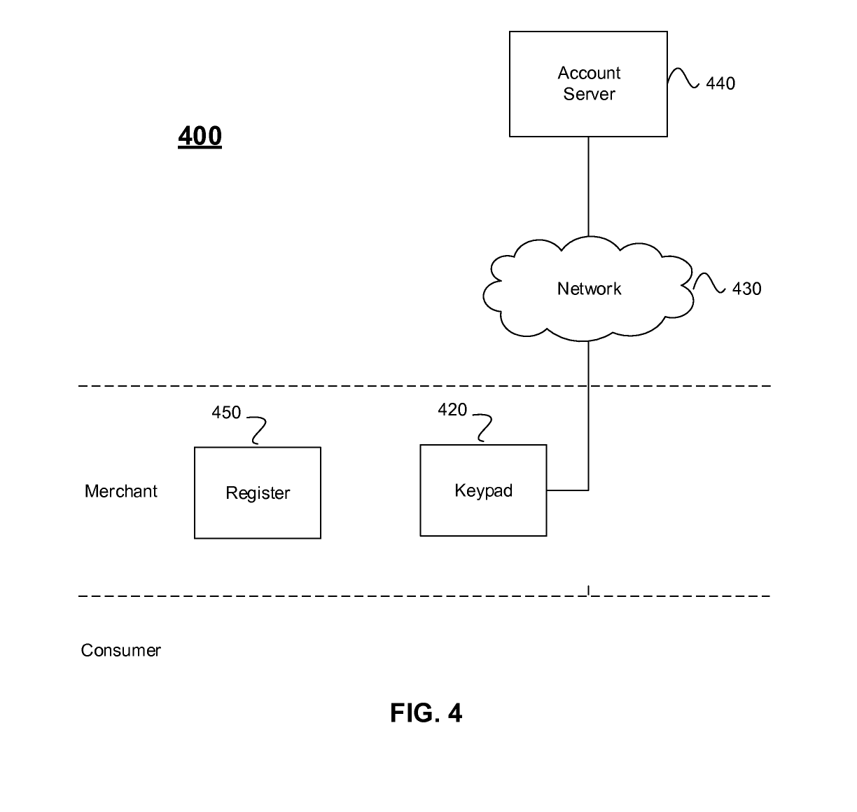

FIG. 4 is a block diagram of a standalone point of sale (POS) system 400 according to an embodiment of the present invention. The standalone POS system 400 is so named because it incorporates the functionality of the consumer keypad 210 and merchant keypad 220 (see FIG. 2) into an existing device with additional software. The standalone POS system 400 includes a merchant keypad 420 and an account server 440. The merchant keypad 420 connects to the account server 440 via a network 430. The merchant may use a register 450 to perform the traditional functions of a cash register. Additional devices may be present, either separate or integrated with the register 450, such as credit and debit card processing devices, etc.

The consumer and the merchant use the merchant keypad 420 to enter the consumer's information and the merchant's information into the payment system 400. This process is similar to that described above with reference to FIGS. 2-3. However, instead of a dedicated device like the consumer keypad 210 (see FIG. 2), the keypad 420 also performs other payment processing functions. For example, the keypad 420 may be a device that performs existing payment processing functions (for example, credit card processing, debit card processing, etc.), with the addition of software functionality that enables the keypad 420 to interface with the payment system 400.

According to one embodiment, the merchant keypad 420 may include a payment device like a VX-510 device from VeriFone Corp., with the addition of software to enable it to interact with the account server 440. Further data entry options for the keypad 420 are discussed below.

The network 430 and the account server 440 may be similar to the network 230 and the account server 240 described above.

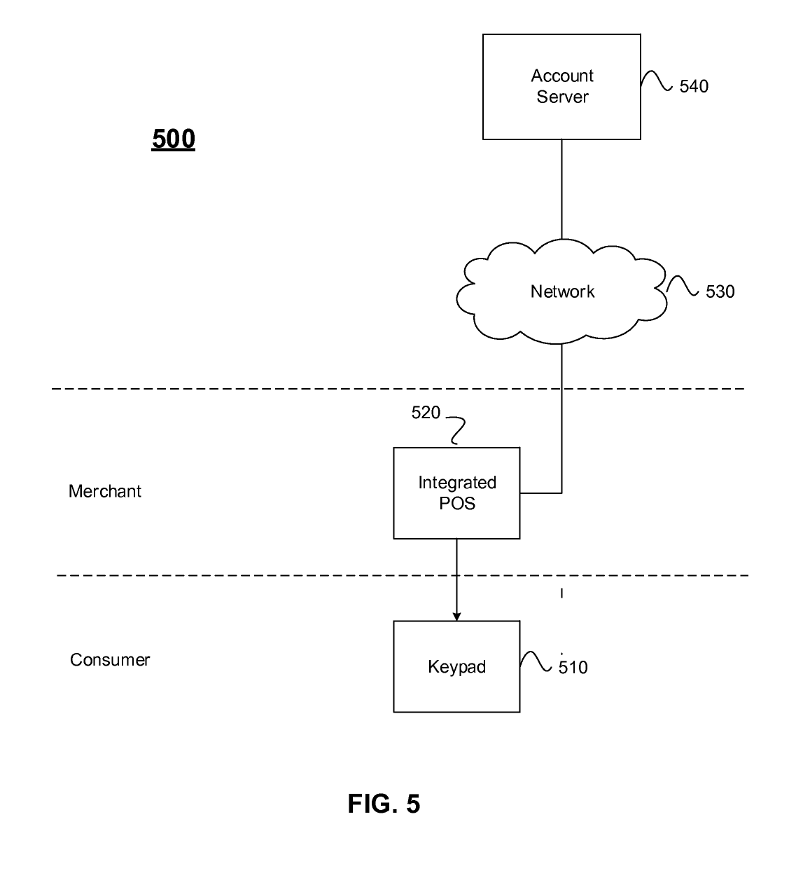

FIG. 5 is a block diagram of an integrated point of sale (POS) system 500 according to an embodiment of the present invention. The integrated POS system 500 is so named because it integrates the functions of a register and a payment system for the merchant. The integrated POS system 500 includes a consumer keypad 510, an integrated register 520, and an account server 540. A network 530 connects the consumer keypad 510 and the integrated register 520 with the account server 540.

The consumer uses the keypad 510 to enter the user's information into the payment system 500. This process is similar to that described above with reference to FIGS. 2-3. The keypad 510 may be implemented in various options and combinations. One option for the keypad 510 is a standalone keypad similar to the keypad 210 (see FIG. 2). Other options for the keypad are discussed below.

Another option for the keypad 510 is to add software to an existing keypad. For example, an existing keypad, such as a debit card processing device or credit card processing device, already performs existing payment transactions. The additional software expands the capabilities of the existing keypad so that it may also connect to the account server 540 in addition to its existing payment transaction functions.

The integrated register 520 includes the traditional functions of a register (pricing, credit and debit card interaction, inventory management, etc.) as well as the functionality to interact with the account server 540. According to one embodiment, the functionality of the merchant keypad 220 (see FIG. 2) is incorporated into the register 520 via software.

The network 530 and the account server 540 are similar to the network 230 and account server 240 described above.

FIG. 6 is a flowchart of an account creation method 600 according to an embodiment of the present invention. The account creation method 600 may occur prior to step 310 (see FIG. 3). For conciseness, the account creation method 600 is described with reference to the basic system 200; however, similar procedures may be used in other embodiments.

In step 610, the consumer enters the consumer's desired account number and desired verification code into the consumer keypad 210. Optionally the consumer may confirm the information entered. The consumer keypad 210 transmits the desired account number and desired verification code to the account server 240 via the network 230.

In step 620, the account server 240 checks that the account number is available and if so, creates an account for the consumer. The account server 240 may transmit confirmation of the account creation to the consumer keypad 210. The account server 240 may also transmit the confirmation to the merchant keypad 220.

In step 630, the consumer funds the consumer's account. According to one embodiment, funding is accomplished by the consumer giving a funding source to the merchant, the merchant entering funding information into the merchant keypad 220, the merchant keypad 220 transmitting the funding information to the account server 240, and the account server 240 updating the consumer's account (and the merchant's account) with the funding information. Various funding sources may be used, including cash, a credit card, a debit card, a gift card, a gift certificate, electronic cash, a PayPal account, a Google Checkout account, etc.

In step 640, the account server 240 communicates confirmation that the consumer's account has been funded. The confirmation may include details of the transaction, such as the date, time, amount, location, etc. The confirmation may be transmitted to the merchant keypad 220, to the consumer keypad 210, or to other devices. The merchant keypad 220 may use the confirmation information to display a message that the transaction has been completed, to print a receipt, etc. The consumer keypad 210 may use the verification information to display a message that the funding has been completed, to display the balance funded, to print a receipt, etc.

The confirmation may also be transmitted to a mobile telephone. According to one embodiment, the consumer's account number is the consumer's mobile telephone number. In such a case, the account server 240 directly uses the consumer's account number to send the confirmation to the consumer's mobile telephone. Such direct access may be contrasted with a system in which the account number differs from the telephone number, which may involve an intermediate database lookup step to get the telephone number for a given account number.

In step 650, the account server 240 performs validation of the consumer's account. Validation of a new account is optional. However, validation may be used in order to provide a higher level of security or to access additional features. Validation involves checking various information beyond the information provided in step 610. The consumer may be asked to provide a name, address, etc. The consumer's name may be checked to see that it matches the consumer's phone number. If the account is funded with a credit card, the credit card information may be validated. The consumer may provide the information for validation in a variety of ways, including via a website, via SMS messaging, via mail, via electronic mail, via telephone conversation, or in person, etc.

The validation procedure may include a grace period. For example, when an account is first created and funded, those funds may be available for use with that specific merchant or at that specific merchant location.

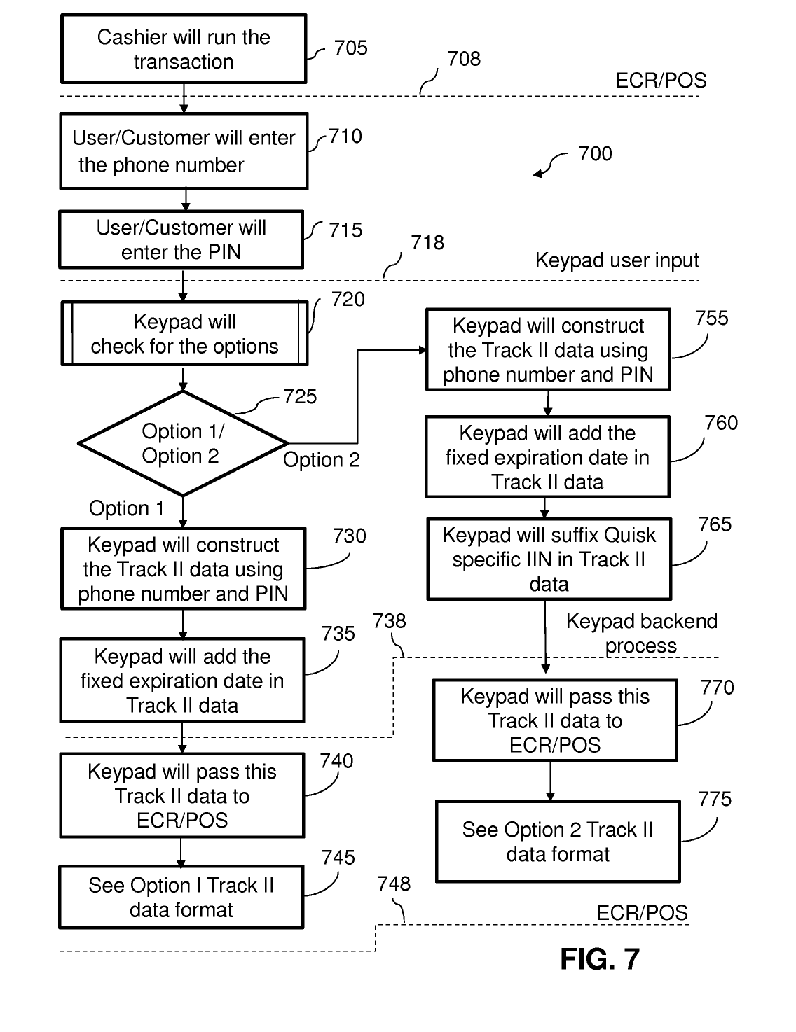

FIG. 7 is a flowchart of a data formatting process 700 according to an embodiment of the present invention. According to one embodiment, the consumer keypad 210 and the account server 240 communicate information in ISO 8583 format.

In step 705, the cashier runs the transaction. The line 708 indicates that the casher may perform this step using an electronic cash register (ECR) or other point of sale (POS) terminal. According to the embodiment of the basic system 200 (see FIG. 2), the ECR/POS may be the merchant keypad 220. According to the embodiment of the integrated POS system 500 (see FIG. 5), the ECR/POS may be the integrated POS 520.

In step 710, the user or customer enters their account number. According to some embodiments, their account number is their phone number.

In step 715, the user or customer enters their PIN. The line 718 indicates that the user may perform steps 710 and 715 using a keypad for user input, for example, the consumer keypad 210.

In step 720, the keypad checks whether an option is set for the ISO 8583 data format. According to the embodiment of the basic system 200 (see FIG. 2), the consumer keypad 210 may perform this step.

In step 725, the keypad proceeds under either option 1 or option 2 depending upon the information obtained in step 720. For option 1, the keypad proceeds to step 730. For option 2, the keypad proceeds to step 755.

In step 730, the keypad constructs Track II data using the consumer's account number (which may be the consumer's phone number) and PIN.

In step 735, the keypad adds a fixed expiration date to the Track II data. The line 738 indicates that the keypad (for example, the consumer keypad 210) may perform the steps 720, 725, 730 and 735 as backend processes.

In step 740, the keypad passes the resulting Track II data to the ECR/POS.

In step 745, the ECR/POS communicates the Track II data to the account server (for example, the account server 240). The line 748 indicates that the ECR/POS may perform the step 745.

The Track II data according to option 1 may be in the following format:

<Phone Number>=<fixed expiration date><PIN><discretionary Data>

where

<Phone Number> is the consumer's account number,

<fixed expiration date> is a fixed expiration date,

<PIN> is the consumer's PIN, and

<discretionary Data> is various additional data.

In step 755, keypad constructs Track II data using the consumer's account number (which may be the consumer's phone number) and PIN.

In step 760, the keypad adds a fixed expiration date to the Track II data.

In step 765, the keypad adds a specific issuer identification number (IIN) to the Track II data. The IIN may be added as a prefix, as a suffix, or otherwise. The IIN may identify a specific issuer, for example, Quisk. The line 738 indicates that the keypad (for example, the consumer keypad 210) may perform the steps 720, 725, 755, 760 and 765 as backend processes.

In step 770, keypad passes the resulting Track II data to the ECR/POS.

In step 775, the ECR/POS communicates the Track II data to the account server (for example, the account server 240). The line 748 indicates that the ECR/POS may perform the step 775.

The Track II data according to option 2 may be in the following format:

<IIN><Phone Number>=<fixed expiration date><PIN><discretionary Data>

where

<IIN> is the issuer identification number,

<Phone Number> is the consumer's account number,

<fixed expiration date> is a fixed expiration date,

<PIN> is the consumer's PIN, and

<discretionary Data> is various additional data.

### Asynchronous Operation

As mentioned previously, the steps of the method 300 need not be performed sequentially. A feature of certain embodiments of the present invention is that the method 300 may be performed asynchronously by the various participants. For example, the consumer may be entering the consumer's information (step 310) at the same time (or after) the merchant is entering the merchant's information (step 340). In such a case, the account server 240 relates the two entries because it knows the locations of the consumer keypad 210 and the merchant keypad 220.

For embodiments that print receipts, the receipt printing may also be performed asynchronously. (This may also be referred to as piecemeal printing.) Some information may be printed when data is first entered into the consumer keypad 210 (step 310) or the merchant keypad 220 (step 340), for example, the name and address of the merchant, the time and date, an identifier for the consumer keypad 210 or the merchant keypad 220, etc. Some other information may be printed when the account has been verified (step 330), such as the account number (or a portion thereof). Some other information may be printed when the merchant information has been received (step 340), such as the transaction amount. Some other information may be printed when the consumer's account has been updated (step 350), such as the new account balance. Some other information may be printed when the account server 240 sends the verification information (step 360), such as a message that the consumer may shortly expect to receive the verification information.

### Tip Entry Option

As a specific example of another asynchronous data entry option, the consumer may also enter a tip (gratuity) when entering the consumer's account number and PIN (step 310). The tip may be entered as an exact amount or as a percentage of the purchase price of the transaction. If the tip information is entered before the merchant transmits the purchase price (step 340), the account server 240 may transmit the tip information to the merchant keypad 220, and the merchant keypad 220 may confirm the tip amount (in the case of an exact amount) or convert the tip percentage to an amount that is transmitted to the account server 240 with the purchase price. If the tip information is entered after the merchant has transmitted the purchase amount, the account server 240 may compute the tip amount (in the case of a percentage tip) and communicate the tip amount to the merchant keypad 220.

### Top Up Process

The term “top up” refers to the consumer adding funds to the consumer's existing account with the account server 240. The procedure is very similar to the basic method 300. One difference is that in step 340, the merchant indicates that the consumer is topping up the consumer's account and enters the amount that the consumer is funding the account into the merchant keypad 220. The consumer may top up the consumer's account using various funding sources (see step 630).

Another difference is that in step 350, the account server 240 indicates in the consumer's account a credit (from the merchant), and in the merchant's account a debit (to the consumer).

The top up process may also be performed as part of a transaction. For example, if the pre-approval process indicates that the consumer's account has a lower balance than the current transaction, the consumer may top up the consumer's account in the middle of, or as part of, the transaction.

### Sub-Accounts

A consumer is not limited to a single account on the account server 240. The consumer may use the consumer's account number to access a variety of sub-accounts. Each sub-account may be associated with a particular merchant, with a particular merchant location, with a particular funding source, or with a particular hierarchy of funding sources. For example, the consumer may have a sub-account A1 that is used when transacting with a specific merchant M1, and a sub-account A2 that is used when transacting with a specific merchant M2. The consumer may have a sub-account A3 that was funded with cash and a sub-account A4 that was funded with a credit card. The consumer may have a sub-account A5 that was funded with both cash and a gift card, in which the gift card portion is to be used up prior to the cash portion. The consumer may have a sub-account A6 that was funded at location L1 of a merchant M3 and a sub-account A7 that was funded at a location L2 of the merchant M3.

One feature of having sub-accounts is that a consumer may use the account server 240 to serve as a repository for gift cards from various merchants. Such a repository increases the convenience for the consumer because the consumer need not remember to possess the gift card when visiting the merchant or to use the gift card when making a purchase from the merchant.

Additionally, a sub-account need not be associated with a funding source. Instead, sub-accounts may be associated with other types of data. One example of such other data is identification cards, such as a library card, a health club ID, etc. The verification requirements for these sub-accounts may be lower than for sub-accounts that are associated with funding sources.

### Communication Options

One way that the account server 240 communicates confirmation and verification information to the consumer is via short message service (SMS) messaging to the consumer's mobile telephone. However, such information may also be communicated in other ways, including voice telephone communication, email, letter, etc.

### Access By Others

In general, a consumer creates and tops off the consumer's own account with the account server 240. However, another entity may also create an account for a consumer, in which case confirmation may be sent to both the consumer and the account creator. For example, one person may create and fund an account for another person as a gift. As another example, a merchant may create and fund an account for a consumer as a promotion to introduce the consumer to the payment system 200 or to the merchant. The recipient could perform the account verification as described above to enable other features.

Similarly, if a consumer already has an account, another entity may top off the consumer's account or add funds to a sub-account as a gift or promotion.

As a specific example, a merchant could purchase a list of mobile telephone numbers and send out promotional accounts via SMS messages.

As another specific example, a person could send money to another person's mobile telephone. To do so, the person may use a keypad at a merchant location even though the transaction is unrelated to the merchant. In such an embodiment, the payment system provides guarantees that the transfer has occurred as well as security of the transaction process.

### Transmission Data Security

According to one embodiment, the account data may be communicated to and from the account server 240 in ISO 8583 format, where the account number and PIN are part of the message. Three methods for secure transmission of the information may be used. First, the account number may appear as-is within the ISO 8583 message. Such formatting may be appropriate when the connection over the network 230 is otherwise encrypted, so that the entire ISO 8583 message is encrypted. Second, the account number may be “tumbled” prior to insertion in the ISO 8583 message and de-“tumbled” upon receipt of the ISO 8583 message. (Tumbling refers to encryption using a long string of numbers known to both parties.) Third, the account number may be encrypted by a method other than tumbling, or both tumbled and encrypted, prior to insertion in the ISO 8583 message.

### Data Entry Options

The term “keypad” has been broadly used to describe any device used for data entry or other interactions with the payment system 100. At its most basic, the keypad (for example, the keypad 210) may include numeric keys for entering the account number and PIN, an ENTER key, and a display. The keypad may also include a printer for printing receipts, transaction confirmations, etc.

Another option for the keypad is to use another type of data entry hardware. Such other data entry hardware may include a radio frequency identification (RFID) reader, an antenna or other wireless interface, a smart card reader, a magnetic strip reader or other card swipe system, a card insertion system, a touch screen, etc. The consumer possesses the corresponding components, such as a RFID tag, a smart card, or a magnetic card, etc., which the consumer uses instead of typing in the consumer's account number manually. The corresponding components may be integrated as part of the consumer's mobile telephone, personal digital assistant (PDA), keyfob, or as separate devices.

For example, the keypad may have a radio frequency identification (RFID) reader that reads a RFID tag implemented as a component of the consumer's mobile telephone. The keypad reads the RFID tag to get the user's account number instead of the user manually entering the account number. The proximity between the consumer, the consumer's mobile telephone, and the keypad helps to reduce fraud.

### Additional Options

Besides the account creation, basic transaction and top up procedures, the consumer may access the consumer's account for other purposes. Such other purposes may include updating the consumer's account information, performing a balance inquiry, etc. Similarly, the merchant may access the merchant's account to perform a balance inquiry, etc.

Besides the systems described above for accessing the account server, access may also be made in other ways. The consumer may access the account server via a website, via text or SMS messaging, via a dedicated application on the consumer's mobile telephone (either built-in or downloaded, for example, a Java application), via a login and menu system on the telephone, via customer support on the telephone, via electronic mail, etc.

Besides transactions between a consumer and a merchant, the account server 240 may also be used for other types of transactions. One example is to transfer money from one consumer's account to another consumer's account. Another example is to convert funds in a consumer's account from one currency to another.

Embodiments of the present invention that use the consumer's telephone number as the account number have a number of advantages. For the consumer, the consumer need not carry cash. The consumer need not carry other funding sources, such as credit cards, debit cards or gift cards. The consumer need not worry about forgetting to bring a gift card to a particular merchant. The consumer can easily remember the consumer's account number. The consumer can easily access a variety of sub-accounts with a single account number. The consumer may quickly receive confirmation of a transaction on the consumer's mobile telephone in proximity to the consumer and to the merchant, reducing fraud.

For the merchant, the consumer may spend more than with cash. The transaction charges to the merchant may be lower than with credit cards or debit cards. The risk of theft is reduced as compared to cash.

For the service provider, directly using the consumer's account number (that is, the mobile telephone number) for verification of a transaction eliminates the need to perform an intermediate database lookup. In addition, it gives the service provider a level of authentication to immediately incorporate a new consumer into the system by directly sending confirmation of the new account creation to a device in close proximity to the consumer and the merchant. The account can be created and the creation confirmed in a single step.

Embodiments of the present invention that implement pre-approval have a number of advantages. The consumer need not wait for the merchant to receive a confirmation that the consumer's account information is correct or that the consumer's account balance is sufficient. The consumer is able to detect and resolve problems with the consumer's account prior to interaction with the merchant regarding the specific details of the transaction. This saves time (on the part of the merchant) and embarrassment (on the part of the consumer).

Embodiments of the present invention that use keypads at a merchant location have a number of advantages. One advantage is that one person may transfer money to another person using the merchant's location as a guarantee of security for the transfer.

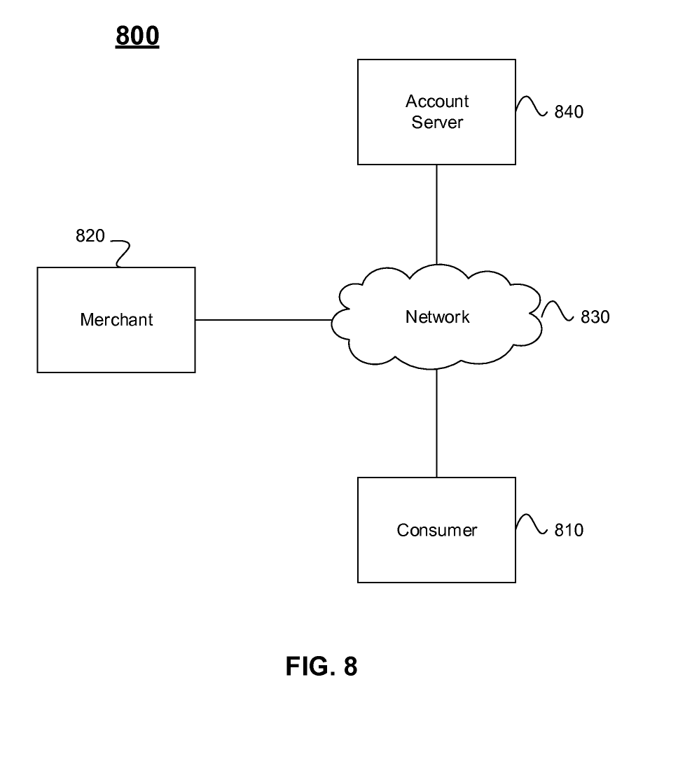

FIG. 8 is a block diagram of a web merchant interface system 800 according to an embodiment of the present invention. The web merchant interface system 800 includes a consumer system 810, a merchant system 820, and an account server 840. A network 830 connects the consumer system 810, the merchant system 820 and the account server 840.

The consumer system 810 allows a consumer or other entity to interact with the merchant system 820 or the account server 840 via the network 830. The consumer system 810 may be implemented as a personal computer that executes a computer program for web browsing. The consumer system 810 may be a mobile communications device that executes a program (such as a JAVA program) for interacting with the merchant system 820 or the account server 840. The consumer system may also be a mobile communications device that interacts with the account server 840 directly, for example, by way of a menu system via a telephone link.

The merchant system 820 allows a merchant or other entity to interact with the consumer system 810 or the account server 840 via the network 830. The merchant system 820 may be implemented as a web server or other type of electronic commerce website. The consumer may interact with the merchant system 820 (via the consumer system 810) to make a purchase or otherwise perform electronic commerce transactions.

The network 830 may be a computer network or other type of communications network, such as the internet.

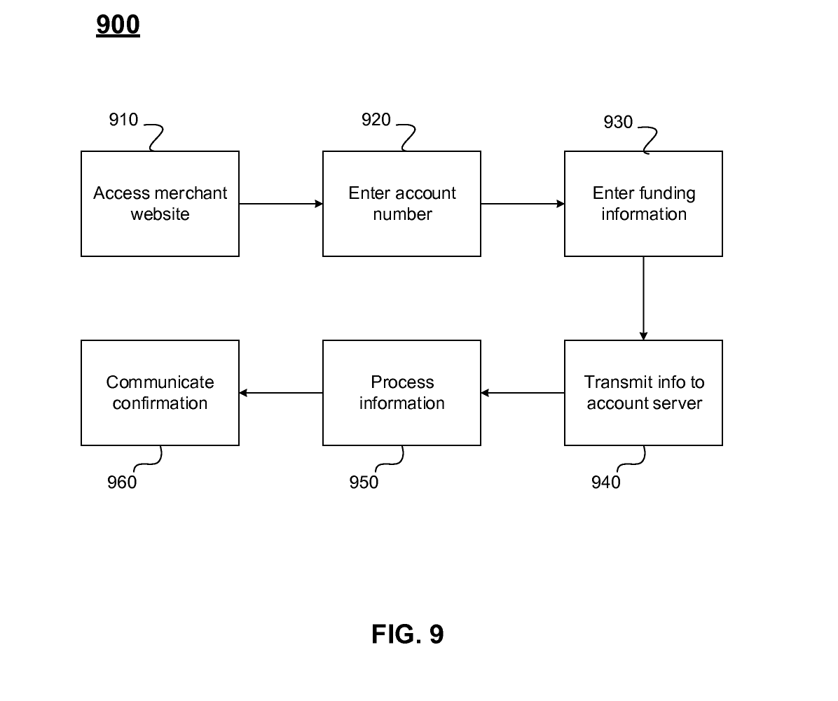

The account server 840 stores account information for the merchant and the consumer. The account server may be implemented as a database program that runs on a computer system. As an example, when the consumer makes a purchase from the merchant, the account server 840 debits the consumer's account and credits the merchant's account. The account server 840 may be similar to the account server 140, the account server 240, the account server 440, or the account server 540 and have similar functionality. For conciseness, such similarities are not repeated. However, the web merchant interface system 800 is useful to illustrate a gift certificate purchase process that is more fully detailed with reference to FIG. 9.

FIG. 9 is a flowchart of a gift certificate purchase process 900 according to an embodiment of the present invention. The gift certificate purchase process 900 may be performed by the web merchant interface system 800.

In step 910, the consumer accesses the merchant's website. The consumer may use the consumer system 810 to access the merchant system 820 via the network 830. For example, the consumer may use a web browsing program to access the merchant's electronic commerce site via the internet. The consumer may perform various electronic commerce functions such as purchasing goods and services, browsing goods and services, etc. For the purposes of illustrating the gift certificate purchase process 900, it is assumed that the consumer is purchasing a gift certificate according to an embodiment of the present invention.

In step 920, the consumer enters an account number to which the consumer wants to give a gift certificate. For ease of description, the entity to whom the consumer wants to give the gift certificate will be referred to as the friend, and this account number will be referred to as the friend's account number. As discussed above with reference to other embodiments of the present invention, the friend's account number may be the friend's mobile telephone number. As an example, the merchant system 820 may serve a web page to the consumer system 810, into which the consumer enters the friend's account number.

In step 930, the consumer enters funding information that indicates the funds the consumer wishes to be placed in the friend's account. As an example, the consumer enters funding information into the web page served by the merchant system 820. Various funding sources may be used, including a credit card, a debit card, a gift card, a gift certificate, electronic cash, a PayPal account, a Google Checkout account, the consumer's account on the account server 840, etc. The merchant system 820 need not verify the friend's account number or the funding information.

In step 940, the merchant transmits the friend's account number and the funding information to the account server 840. The merchant system 820 may transmit this information via the network 830.

In step 950, the account server 840 processes the friend's account number and the funding information. If the friend does not yet have an account, then the account server 840 creates an account for the friend. The account server 840 updates the friend's account with a credit for the funded amount. The account server 840 executes processing so that the consumer's funding source receives a debit. For example, if the consumer is funding with a credit card as the source, the account server 840 may interact with a credit card service provider. As another example, if the consumer is funding with the consumer's account on the account server 840 as the source, the account server 840 may update the consumer's account.

As a further option, the account server 840 may fund a sub-account of the friend's account that is related to the merchant. The consumer may indicate that the gift is to be applied to the sub-account, or the merchant system 820 may indicate that the gift is to be applied to the sub-account. The friend may also indicate that the gift is to be applied to the sub-account, for example, by setting various gift receipt options in the friend's account on the account server 840. For example, if the consumer is purchasing a gift certificate for the friend from the XYZ.com website, the friend's sub-account associated with XYZ.com may be funded.

In step 960, the account server 840 sends confirmation that the friend's account has been funded. The confirmation may include details of the transaction, such as the date, time, amount, location, etc. The confirmation may be transmitted to the merchant system 820, for example, so that it knows that the account server 840 has acted on the merchant system's transmission in step 940. The merchant system 820 may also use the confirmation to update information it stores regarding the consumer or the friend, for example, as part of its personal data collection procedures. The merchant system 820 may transmit its own confirmation to the consumer system 810.

The confirmation may be transmitted to the friend. According to an embodiment of the present invention, the friend's account number is the friend's mobile telephone number. In such a case, the account server 840 directly uses the friend's account number to send the confirmation to the friend's mobile telephone number. Such direct access may be contrasted with a system in which the account number differs from the telephone number, which may involve an intermediate database lookup step to get the telephone number for a given account. The confirmation may be in the form of an SMS message.

The confirmation may be transmitted to the consumer system 810. For example, if the consumer has funded the gift with a credit card, the credit card company may provide the consumer's email address to the account server 840. The merchant system 820 may have provided the consumer's email address to the account server 840 along with the information transmitted in step 940.

The confirmation may be transmitted to the consumer's mobile telephone. For example, if the consumer has funded the gift with a credit card, the credit card company may provide the consumer's telephone number to the account server 840. The merchant system 820 may have provided the consumer's telephone number to the account server 840 along with the information transmitted in step 940. The confirmation may be in the form of an SMS message.

If the consumer funded the account with the consumer's account on the account server 840, the account server 840 may send a separate confirmation that indicates a debit on the consumer's account. Such confirmation may be similar to the confirmation sent as part of the normal process of making purchases using the consumer's account, discussed above with reference to step 360.

As an additional security feature of the gift certificate purchase process 900, interaction between the friend and the consumer may be performed to validate the gift. The confirmation to the friend (see step 960) may include a validation code. The friend contacts the consumer and provides the validation code. Such contact may be via voice, text message, etc. The consumer then knows that the gift was given to the friend as intended. The consumer may then access the account server 840 (for example, via the consumer system 810) and provide the validation code. The account server 840 then validates the gift for use by the friend.

### Methods for Processing a Payment Transaction

Disclosed herein are methods for enabling a payment service to process a payment transaction. A transfer of funds to affect payment for a payment transaction may be administered by a payment system via a stored fund account, an electronic wallet or a prepaid account.

In one embodiment, a method, in which each step is computer-implemented, includes the steps of receiving, via a point of sale terminal operated by a merchant, a mobile device telephone number of a mobile device associated with a user, and a personal identification number selected by the user. The mobile device telephone number is checked against a database of account numbers administrated by a payment service to determine if the mobile device telephone number is already present in the first database. A payment account for the user is created using an account server if the mobile device telephone number is not already associated with a payment account in the database. The mobile device telephone number serves as an account number for the payment account. An account confirmation message is transmitted to the mobile device associated with the user via direct use of the account number for the payment account. A transfer of funds to affect payment for a payment transaction is administered via a stored fund account. The stored fund account is associated with the account number, and is a ledger of actual funds located in a second account.

Administering the transfer of funds may include checking the stored fund account for available funds. A withdrawal from or a deposit to the stored fund account may be recorded in the ledger based on the payment transaction associated with the stored fund account. A settlement statement may be transmitted to one or more financial institutions. The settlement statement may be for withdrawals from or deposits to the second account based on the payment transactions associated with the stored fund account. The settlement statement may be transmitted at the end of the day. The second account may be located at the financial institution.

The account numbers may be the primary key of each record in the database, and may be dialable device numbers. Since the primary key of the database is the device number, and the device number can be dialed to contact the account holder, identifying, contacting, and verifying the account holder can all be done using discrete tasks that do not require intermediate lookup steps. The account server and the stored fund account may be managed by a single entity. The stored fund account may reside on the account server.

In one implementation, the second account may be uniquely associated with the user. In another implementation, the second account may be a pooled account associated with one or more stored fund accounts. A request statement may be transmitted to one or more financial institutions detailing net transfers associated with the pooled account. The request statement could include information regarding net transfers between stored fund accounts that reside at the account server, or the statement could be limited to information regarding net transfers out of the pooled account. If the financial institution was required to keep a record of proportional ownership of the pooled account, the statement would need to be the more detailed report involving net transfers between stored fund accounts. The request statement may be transmitted at the end of the day.

In another embodiment, a method, in which each step is computer-implemented, includes the steps of receiving, via a point of sale terminal operated by a merchant, a mobile device telephone number of a mobile device associated with a user, and a personal identification number selected by the user. The mobile device telephone number is checked against a database of account numbers administrated by a payment service to determine if the mobile device telephone number is already present in the first database. A payment account for the user is created using an account server if the mobile device telephone number is not already associated with a payment account in the database. The mobile device telephone number serves as an account number for the payment account. An account confirmation message is transmitted to the mobile device associated with the user via direct use of the account number for the payment account. A transfer of funds to affect payment for a payment transaction is administered via an electronic wallet. The electronic wallet is associated with the account number, stores funding source information, and is stored in an electronic memory that is administrated by the account server. The funding source information is one of a credit card number, a debit card number, a gift card number or a bank account number.

The account numbers may be the primary key of each record in the database, and may be dialable device numbers. In one implementation, administering the transfer of funds may comprise transmitting the funding source information to a merchant on behalf of the user. The merchant may utilize the funding source information to process the payment transaction. In another implementation, administering the transfer of funds may comprise transferring funds from a stored value account that resides at the account server. The funding source information may comprise a balance of the stored value account, a credit card account number, an automated clearing house routing number, or a demand deposit financial institution specific account number. The payment transaction may be processed through a third party payment processor, an automated clearing house or a credit card network.

The method further may comprise transmitting a transaction complete notification via direct use of the account number, to the mobile device associated with the user. The transaction complete notification may identify a specific funding source used for the payment transaction.

In another embodiment, a method, in which each step is computer-implemented, includes the steps of receiving, via a point of sale terminal operated by a merchant, a mobile device telephone number of a mobile device associated with a user, and a personal identification number selected by the user. The mobile device telephone number is checked against a database of account numbers administrated by a payment service to determine if the mobile device telephone number is already present in the first database, or if the mobile device telephone number is already associated with a payment account in the first database. A payment account for the user is created using an account server if the mobile device telephone number is not already associated with an existing payment account in the database. The mobile device telephone number serves as an account number for the payment account. The payment account is associated with a prepaid account. The prepaid account may be used to pay for usage of the mobile device associated with the user. An account confirmation message may be transmitted, via direct use of the account number for the payment account, to the mobile device associated with the user. A transfer of funds to affect payment for a payment transaction is administered via the prepaid account. The prepaid account stores funds that are administrated by the mobile device provider for the benefit of the user.

The administering the transfer of funds may comprise transferring funds from the prepaid account to a merchant, and may adjust a balance of the prepaid account based on the payment transaction. The method may further comprise transmitting an information statement to the mobile device telephone number associated with the user. The information statement may detail the payment transactions associated with the prepaid account, and may be transmitted at the end of the day.

In one implementation, the method may further comprise transferring a portion of the funds from the prepaid account to a second prepaid account. The second prepaid account may be associated with a second user. The prepaid account and the second prepaid account may be accounts at a single mobile device provider.

### The Stored Fund Account

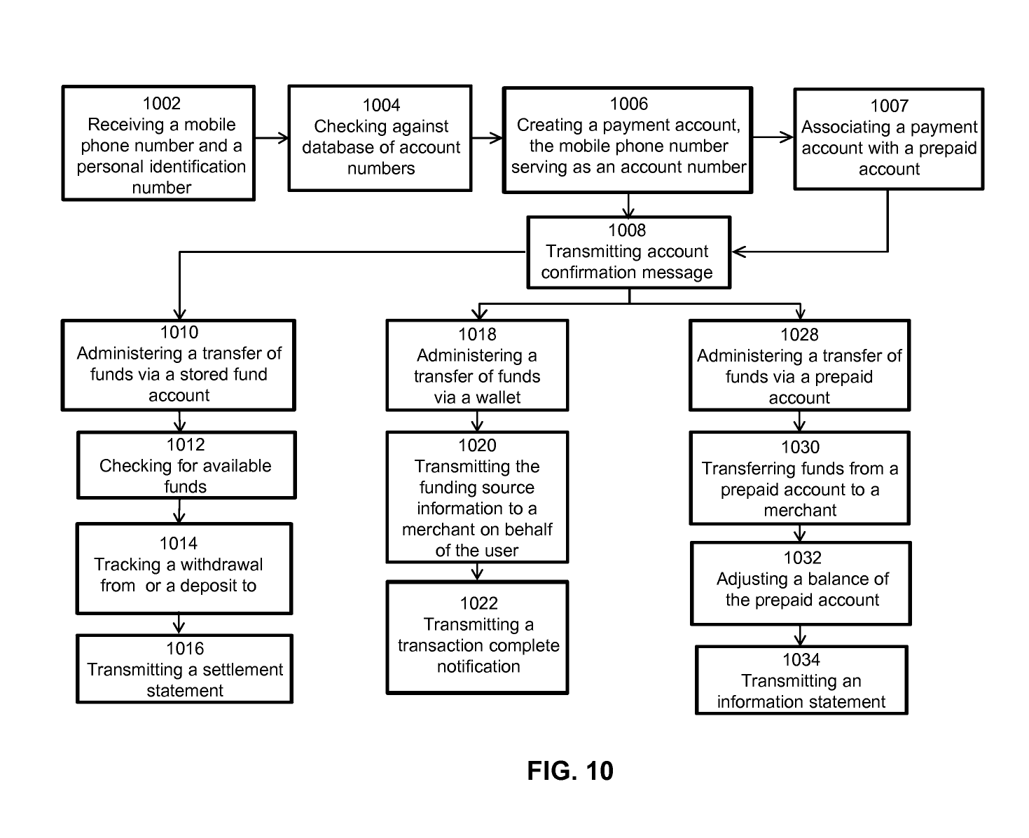

FIG. 10 is an example flowchart for methods for enabling a payment service to process a payment transaction. The method begins at step 1002 by receiving, via a point of sale terminal operated by a merchant, a mobile device telephone number of a mobile device associated with a user, and a personal identification number selected by the user. At step 1004, the mobile device telephone number is checked against a database of account numbers administrated by a payment service to determine if the mobile device telephone number is already present in the first database. At step 1006, a payment account for the user is created using an account server if the mobile device telephone number is not already associated with a payment account in the database. The mobile device telephone number serves as an account number for the payment account. At step 1008, an account confirmation message is transmitted to the mobile device associated with the user via direct use of the account number for the payment account.

At step 1010, a transfer of funds to affect payment for a payment transaction is administered via a stored fund account. Optionally, administering a transfer of funds via an electronic wallet (step 1018) and prepaid account (step 1028) are discussed hereafter. The stored fund account is associated with the account number, and is a ledger of actual funds. The actual funds are located in a second account.

The second account containing the actual funds may be located at a financial institution such as a bank or credit union. In one embodiment, the second account may be uniquely associated with the user such as a single user and a single stored fund account. In various embodiments, the second account may be associated with a single user and multiple stored fund accounts, or the second account may be associated with multiple users and a single stored fund account, or the second account may be associated with multiple users and multiple stored fund accounts.

At step 1012, the stored fund account may be checked for available funds by an account server. At step 1014, a withdrawal from or a deposit to the stored fund account may be recorded in the ledger based on the payment transaction associated with the stored fund account. At step 1016, a settlement statement may be transmitted to the one or more affiliate financial institutions for withdrawals from or deposits to the second account based on the payment transactions associated with the stored fund account. This may be transmitted at the end of the day such as at the close of business or during the middle of the night when financial institutions typically perform batch processing.

The account numbers may be the primary key of each record in the database, and may be dialable device numbers. By utilizing the mobile device telephone number of a mobile device as the account number, a number of advantages are obtained. For the consumer, also referred to as customer or user, the consumer need not carry cash. The consumer need not carry other funding sources, such as credit cards, debit cards or gift cards. For example, the consumer need not worry about forgetting to bring a gift card to a particular merchant. The consumer can easily remember the mobile device telephone number of a mobile device as the account number. The consumer can easily access a variety of sub accounts with a single account number. The consumer may quickly receive confirmation of a transaction on the mobile device telephone number of a mobile device in proximity to the consumer and to the merchant, reducing fraud.

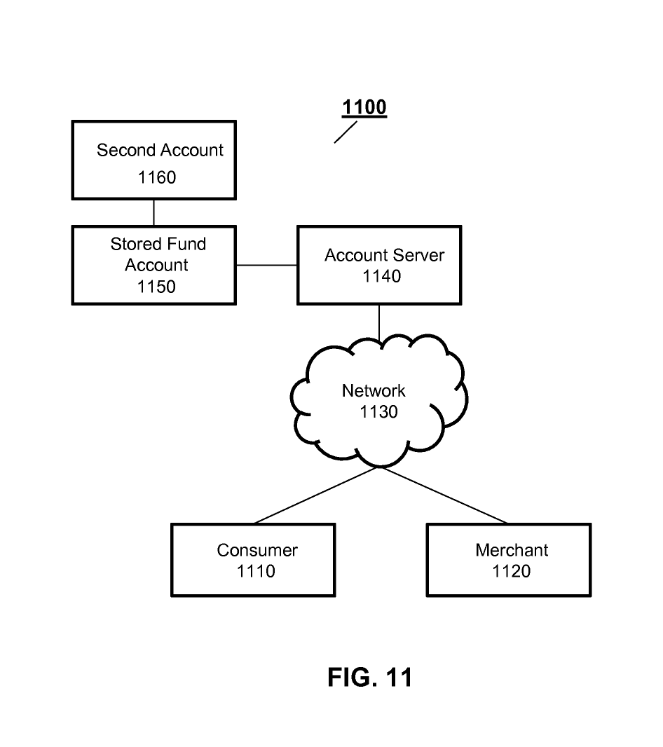

FIG. 11 illustrates an example system to affect payment for a payment transaction via a stored fund account. This may be used in place of account server 240, 440, 540 and 840 in FIGS. 2, 4, 5 and 8 respectively, described herein. In one implementation, the payment transaction may be initiated by the consumer 1110. In another implementation, the payment transaction may be initiated by the merchant 1120. For example, in system 1100, when the consumer 1110 would like to make a purchase with a merchant 1120, the merchant 1120 may access the account server 1140 through the network 1130. The account server 1140 checks the stored fund 1150 using the mobile device telephone number of a mobile device associated with a user as the account number for available funds. If sufficient funds are available, the ledger of the stored fund 1150 is updated reflecting the transaction such as a withdrawal or deposit. The merchant 1120 receives authorization that the payment transaction may proceed and processes the payment transaction. The payment transaction may be processed through a third party payment processor, an automated clearing house or a credit card network. This authorization process happens very quickly, such as in a matter of seconds.

A settlement statement may be transmitted to a financial institution for a withdrawal from or deposit to a second account 1160, based on the payment transaction associated with the stored fund account 1150. This may be transmitted at the end of the day. The settlement statement may detail every withdrawal from or deposit to stored fund account 1150 occurring throughout the day, or detail only the net transfer to stored fund account 1150 that need to be reflected by the second account 1160.

Moreover, the stored fund account may reside on the account server. As discussed herein, the account server 1140 may be implemented on a computer system. The computer system includes hardware and software for storing the account data and updating the account data in accordance with authorized transactions. The account server and the stored fund account may be managed by a single entity such as a bank, credit union or the like.

In an example embodiment, the second account 1160 may be a pooled account associated with one or more stored fund accounts. For example, the actual funds are located at a bank in a second account 1160 shared by multiple users with different stored fund accounts like stored fund account 1150. The bank may not be aware of the percentage of the actual funds belonging to each individual user or stored fund account. Instead, only account server 1140 is aware of the percentage of the actual funds belonging to each individual user because it is kept track of by way of the ledger of each of the stored fund accounts. However, in certain situations both the financial institution administrating second account 1160, and the payment service administrating account server 1140 may keep track of the individual ownership of the funds in pooled account 1160 via the delivery of a settlement report from account server 1140 that details the net change in position of each stored fund account associated with second account 1160.

A request statement may be transferred to one or more financial institutions detailing net transfers associated with the pooled account. The request statement may be transmitted at the end of the day. This is a condensed summary of the net change to the pooled account based on the transactions throughout the day. For example, during the day, all transactions pertaining to the pooled account are recorded in the ledger for each stored fund account. After the close of business, the account server may transmit a request statement to the affiliate financial institutions detailing net transfers associated with the pooled account. In one embodiment, the request statement details net transfers associated with the pooled account, not every transaction occurring throughout the day. For example, if a consumer with the stored fund account (where the second account is a pooled account associated with one or more stored fund accounts), made a purchase for $50, then a deposit for $200, then a purchase for $30, the request statement to the affiliate financial institution may detail that the account balance of the second account be increased by $120. The individual transactions are not included on the request statement.

In a larger scale example, where the second account is a pooled account associated with many stored fund accounts, thousands of transactions may occur throughout the day that pertain to the pooled account. The request statement is transmitted at the end of the day detailing only the net transfers associated with the pooled account. For example, the request statement to the affiliate financial institutions may detail that the account balance of the second account be decreased by a hundred thousand dollars, and specify a collection of account at other financial institutions to which those funds should be dispersed via wire transfers or the like.

The system may include a transfer of the funds to a temporary account associated with the administrator of the payment service. This account may be a pooled administrator account. The transfer of funds may also include a transfer of funds directly from the funding source on the account to a funding sink that is identified in the account of a different member of the payment service. Funding sinks and funding sources may take various forms such as credit cards, bank accounts, gift cards, or the like. The payment instruments that are identified in the account of a user may be both funding sources and funding sinks. However, certain payment system participants may have accounts that are solely payment sinks. For example, merchants in the system may only be set to receive payments and their payment instruments may not be capable of being used as a funding source.

### The Electronic Wallet

A transfer of funds to affect payment for a payment transaction may be administered by an electronic wallet. Referring to FIG. 10, the steps 1002, 1004, 1006 and 1008, described previously, are executed. At step 1018, a transfer of funds to affect payment for a payment transaction is administered via an electronic wallet. Optionally, administering a transfer of funds via a stored fund account (step 1010) and prepaid account (step 1026) are discussed previously and hereafter, respectively. The electronic wallet is associated with the account number. For example, the electronic wallet is associated with a mobile device telephone number of a mobile device associated with a user. The electronic wallet stores funding source information, not actual funds, for various sources. The funding source information may be one of a credit card number, a debit card number, a gift card number or a bank account number. The electronic wallet is stored in an electronic memory such as a database, which may be administrated by the account server.

The account numbers may be the primary key of each record in the database, and may be dialable device numbers. At step 1020, the funding source information is transmitted to a merchant on behalf of the user. At step 1022, a transaction complete notification is transmitted via direct use of the account number, to the mobile device associated with the user. The transaction complete notification identifies a specific funding source used for the payment transaction. For example, once the payment transaction is complete, the user may receive a text or call to the mobile device associated with the user by direct use of the account number identifying the credit card used in the payment transaction.

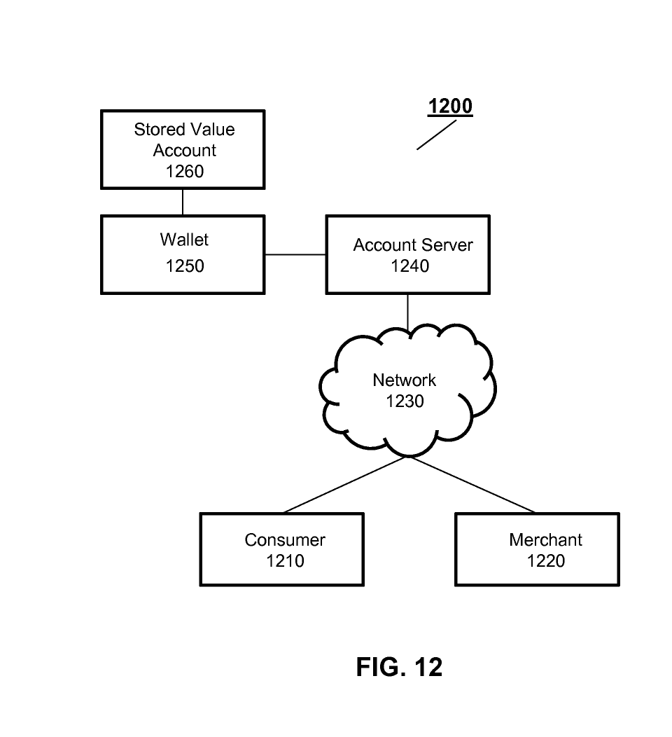

FIG. 12 illustrates an example system to affect payment for a payment transaction via an electronic wallet. The system 1200 allows the electronic wallet 1250 to store funding source information for various funding sources. In one implementation, the payment transaction may be initiated by the consumer 1210. In another implementation, the payment transaction may be initiated by the merchant 1220. For example, in system 1200, when the consumer 1210 would like to make a purchase with a merchant 1220, the merchant 1220 may access the account server 1240 through the network 1230. The account server 1240 accesses the funding source information in the electronic wallet 1250, and the funding source information is transmitted to the merchant 1220 on behalf of the consumer 1210. The funding source information may be a credit card number, a debit card number, a gift card number or a bank account number.

The merchant 1220 then utilizes the funding source information to process the payment transaction. The payment transaction may be processed through a third party payment processor, such as an automated clearing house or a credit card network. After the transaction is processed, a transaction complete notification can then be transmitted via direct use of the account number, to the mobile device associated with the user. The user may receive a text or call to their mobile device identifying the specific funding source used for the payment transaction.

In one embodiment, the funding source information in the electronic wallet 1250 comprises a balance of a stored value account 1260. The administering the transfer of funds comprises transferring funds from a stored value account 1260 that may be administrated by the account server 1240.

The system may allow the electronic wallet to store funding source information for various funding sources for transactions conducted using an account. For example, the account server 1240 may include a relational database that associates the account number (the mobile device telephone number serving as an account number) with a set of funding sources that are associated with the owner of the account. The account owner may then conduct a transaction using the payment system that involves a transfer of funds from their account number to another account number which may be owned by a different user having a different account number, and hence, a different mobile device telephone number serving as an account number in the payment system.

### The Prepaid Account

A transfer of funds to affect payment for a payment transaction may be administered via a prepaid account. The prepaid account can be associated with a mobile telephone such that payments for usage of the mobile device are deducted from the balance of the account. The account can be administered by the mobile device provider and can be reflective of funds held by a financial institution on behalf of the mobile device provider. Referring to FIG. 10, the method begins at step 1002 with receiving, via a point of sale terminal operated by a merchant, a mobile device telephone number of a mobile device associated with a user, and a personal identification number selected by the user. In step 1004, the mobile device telephone number is checked against a database of account numbers administrated by a payment service to determine if the mobile device telephone number is already present in the first database, or if the mobile device telephone number is already associated with a payment account in the first database. At step 1006, a payment account for the user is created using an account server if the mobile device telephone number is not already associated with an existing payment account in the database. The mobile device telephone number serves as an account number for the payment account. At step 1007, the payment account is associated with a prepaid account. The prepaid account may be the prepaid account used to pay for usage of the mobile device associated with the user.

At step 1008, an account confirmation message is transmitted to the mobile device associated with the user via direct use of the account number for the payment account. At step 1028, a transfer of funds to affect payment for a payment transaction is administered via the prepaid account. The prepaid account stores funds that are administrated by the mobile device provider for the benefit of the user.

Administering the transfer of funds includes, at step 1030, transferring funds from the prepaid account to a merchant. At step 1032, a balance of the prepaid account is adjusted based on the payment transaction. At step 1034, an information statement is transmitted to the mobile device telephone number associated with the user. The information statement details the payment transactions associated with the prepaid account. The information statement may be transmitted at some time following the close of business or during the middle of the night when financial institutions typically perform batch processing.

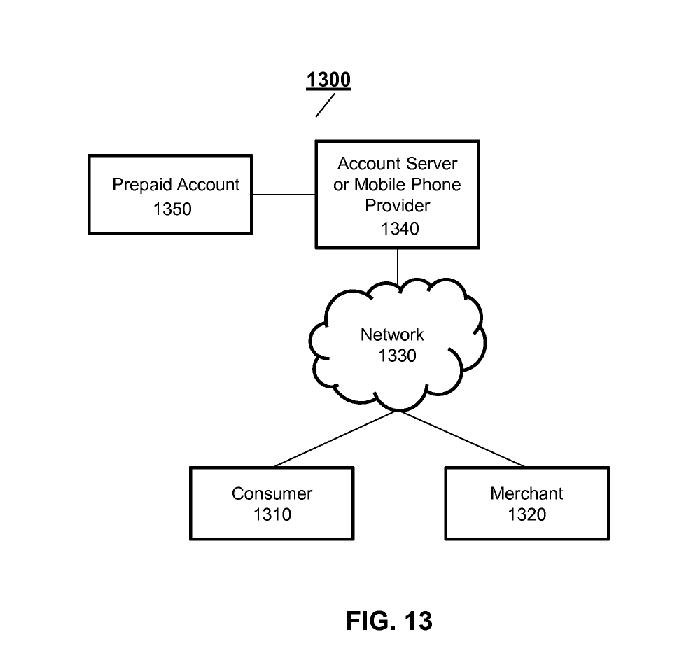

FIG. 13 illustrates an example system to affect payment for a payment transaction via a prepaid mobile device account. In one implementation, the payment transaction may be initiated by the consumer 1310. In another implementation, the payment transaction may be initiated by the merchant 1320. For example, in system 1300, when the consumer 1310 would like to make a purchase with a merchant 1320, the merchant 1320 may access the account server 1340 through the network 1330. The account server 1340, administrates a transfer of via the prepaid account 1350. If sufficient funds are available, the merchant 1320 receives authorization that the payment transaction may proceed and processes the payment transaction. This authorization process happens very quickly, such as in a matter of seconds. At a later time, funds can be transferred from an account at a financial institution that holds the funds represented by the prepaid account for the benefit of the mobile device provider, to an account owned by the merchant. The merchant can identify this account ahead of time to the mobile device provider and configure the account such that transfers from the financial institution can occur in a frictionless manner with regularity. An information statement may be transmitted to the mobile device of the user by call or text detailing the payment transactions associated with the prepaid account. The information statement may be transmitted immediately, at the end of the day such as at the close of business, or during the middle of the night when financial institutions typically perform batch processing.

In one embodiment, administering the transfer of funds includes transferring a portion of the funds from the prepaid account to a second prepaid account. The second prepaid account may be associated with a second user. The second prepaid account may store funds that are administrated by the mobile device provider for the benefit of the second user, and may be used to pay for usage of a second mobile device associated with the second user. For example, a user may make withdrawals or deposits from their prepaid account to a second prepaid account associated with another user within the system. The second user may be a person or merchant.

In another embodiment, the prepaid account may be solely a funding sink. For example, merchants with prepaid accounts in the system may only be set to receive payments and may not be capable using their prepaid account as a funding source.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method, in which each step is computer-implemented, comprising the steps of:
receiving, via a point of sale terminal operated by a merchant, (i) a mobile device telephone number of a mobile device associated with a user and (ii) a personal identification number selected by the user;
checking the mobile device telephone number against a first database of account numbers administrated by a payment service to determine if the mobile device telephone number is already present in the first database;
creating a payment account for the user using an account server if the mobile device telephone number is not already in the first database, the mobile device telephone number serving as an account number for the payment account;
transmitting, via direct use of the account number for the payment account, an account confirmation message to the mobile device associated with the user; and
administering a transfer of funds to affect payment for a payment transaction via a stored fund account;
wherein the stored fund account: (i) is associated with the account number, and (ii) is a ledger of actual funds, the actual funds being located in a second account.

2. The method of claim 1, wherein administering the transfer of funds comprises:
checking the stored fund account for available funds;
recording a withdrawal from or a deposit to the stored fund account in the ledger based on the payment transaction associated with the stored fund account; and
transmitting a settlement statement to one or more financial institutions, the settlement statement being for withdrawals from or deposits to the second account based on the payment transactions associated with the stored fund account;
wherein the second account is located at the financial institution.

3. The method of claim 2, wherein the settlement statement is transmitted at the end of the day.

4. The method of claim 1, wherein the account numbers are: (i) the primary key of each record in the database, and (ii) are dialable device numbers.

5. The method of claim 1, wherein the second account is uniquely associated with the user.

6. The method of claim 1, wherein the second account is a pooled account associated with one or more stored fund accounts.

7. The method of claim 6, further comprising:
transmitting a request statement to one or more financial institutions, the request statement detailing net transfers associated with the pooled account;
wherein the request statement is transmitted at the end of the day.

8. The method of claim 1, wherein the account server and the stored fund account are managed by a single entity.

9. The method of claim 1, wherein the stored fund account resides on the account server.

10. A method, in which each step is computer-implemented, comprising the steps of:
receiving, via a point of sale terminal operated by a merchant, (i) a mobile device telephone number of a mobile device associated with a user and (ii) a personal identification number selected by the user;
checking the mobile device telephone number against a first database of account numbers administrated by a payment service to determine if the mobile device telephone number is already present in the first database;
creating a payment account for the user using an account server if the mobile device telephone number is not already in the first database, the mobile device telephone number serving as an account number for the payment account;
transmitting, via direct use of the account number for the payment account, an account confirmation message to the mobile device associated with the user; and
administering a transfer of funds to affect payment for the payment transaction via an electronic wallet;
wherein the electronic wallet: (i) is associated with the account number, (ii) stores funding source information, and (iii) is stored in an electronic memory that is administrated by the account server; and
wherein the funding source information is one of a credit card number, a debit card number, a gift card number or a bank account number.

11. The method of claim 10, wherein administering the transfer of funds comprises:
transmitting the funding source information to a merchant on behalf of the user;
wherein the merchant utilizes the funding source information to process the payment transaction.

12. The method of claim 10, wherein administering the transfer of funds comprises:
transferring funds from a stored value account that is administrated by the account server;
wherein the funding source information comprises a balance of the stored value account.

13. The method of claim 10, wherein the payment transaction is processed through a third party payment processor, an automated clearing house or a credit card network.

14. The method of claim 10, further comprising:
transmitting a transaction complete notification via direct use of the account number, to the mobile device associated with the user, the transaction complete notification identifying a specific funding source used for the payment transaction.

15. The method of claim 10, wherein the account numbers are: (i) the primary key of each record in the database, and (ii) are dialable device numbers.

16. A method, in which each step is computer-implemented, comprising the steps of:
receiving, via a point of sale terminal operated by a merchant, (i) a mobile device telephone number of a mobile device associated with a user and (ii) a personal identification number selected by the user;
checking the mobile device telephone number against a first database of account numbers administrated by the payment service to determine if: (i) the mobile device telephone number is already present in the first database, and (ii) the mobile device telephone number is already associated with a payment account in the first database;
creating a payment account for the user using an account server if the mobile device telephone number is not already associated with an existing payment account in the first database, the mobile device telephone number serving as an account number for the payment account;
associating the payment account with a prepaid account, wherein the prepaid account is used to pay for usage of the mobile device associated with the user;
transmitting, via direct use of the account number for the payment account, an account confirmation message to the mobile device associated with the user; and
administering a transfer of funds to affect payment for a payment transaction via the prepaid account;
wherein the prepaid account stores funds that are administrated by the mobile device provider for the benefit of the user.

17. The method of claim 16, wherein administering the transfer of funds comprises:
transferring funds from the prepaid account to a merchant; and
adjusting a balance of the prepaid account based on the payment transaction.

18. The method of claim 16, wherein administering the transfer of funds comprises:
transferring a portion of the funds from the prepaid account to a second prepaid account, the second prepaid account being associated with a second user;
wherein the second prepaid account: (i) stores funds that are administrated by the mobile device provider for the benefit of the second user; and (ii) is used to pay for usage of a second mobile device associated with the second user.

19. The method of claim 16, further comprising:
transmitting an information statement to the mobile device telephone number associated with the user, the information statement detailing the payment transactions associated with the prepaid account;
wherein the information statement is transmitted at the end of the day.
